(19) United States
(12) Patent Application Publication
(10) Pub. No.: US 2016/0069488 A1
(43) Pub. Date: Mar. 10, 2016

(54) REINFORCING SLEEVE FOR A COUPLING, ASSEMBLY OF A REINFORCING SLEEVE AND A COUPLING, METHOD OF WELDING OF FOR INSTANCE A MULTI LAYER CONDUIT TO THE ASSEMBLY

(71) Applicant: TERSIA B.V., Roosendaal (NL)

(72) Inventor: Cornelis Augustinus VAN DER DONK, Roosendaal (NL)

(21) Appl. No.: 14/785,945

(22) PCT Filed: Apr. 22, 2014
(86) PCT No.: PCT/NL2014/050259

§ 371 Date: Oct. 21, 2015

(30) Foreign Application Priority Data
Apr. 22, 2013 (NL) 2010686

(51) Int. Cl. F16L 13/04; B29C 65/02; F16L 21/08

(52) U.S. Cl. CPC F16L 13/04; F16L 21/08; B29C 65/02; B29L 2031/24

(57) ABSTRACT

A substantially tubular reinforcing sleeve is disclosed and is designed for placing inside a coupling pipe in an assembly with the coupling pipe which forms part of a coupling. The sleeve is provided with a slit extending at least in axial direction of the reinforcing sleeve, and the slit is enclosed by slit edges of the reinforcing sleeve. The slit edges define an intermediate space which is variable in that the sleeve takes a flexible and resilient form. The dimensions and the form of the reinforcing sleeve are chosen such that the contour of the reinforcing sleeve can be placed inside a coupling pipe and there connects closely to an inner wall of the coupling pipe after placing. The reinforcing sleeve optionally includes toothings for fixation to the coupling pipe. A method is further disclosed for welding an outer end of a multilayer conduit to the above stated assembly.

The invention relates to a reinforcing sleeve for a coupling, for instance for multilayer conduits, particularly for a coupling suitable for socket welding (international term: polyfusion welding) of for instance multilayer conduits.

Multilayer conduits are applied for plastic conduit systems (PCS) and thus form an alternative to conduits of steel and copper. The conduits are used for, among other purposes, the supply and discharge of water, gas and chemical substances.

The great advantage of these multilayer conduits is that they can bend in form-retaining manner, in a manner similar to copper conduits, while they are in comparison much lighter in weight and less expensive. A good example are polyethylene pipes constructed from an aluminium layer with a layer of polyethylene on either side. Such pipes are flexible and have a proven strength for the intended applications. Particularly interesting are pipes based on PE-RT (PE-Raised Temperature, a product of Dowlex), which can withstand temperatures of 90-95° C. and can be applied at pressures of up to 10 bar.

Polyfusion welding is a suitable technique for coupling multilayer conduits to each other by means of a coupling, wherein a coupling and an outer end of a conduit for coupling are heated, for instance with a welding mandrel or other heating apparatus, until the parts for coupling become plastic. In plastic state the two parts are then fused together by pressing or sliding the parts for coupling against or into each other and allowing them to cool.

Used as heat source in polyfusion welding is a lance, the outer end of which is provided with mountable heating elements, also known as a welding mandrel and weld bush. The welding mandrel and weld bush are shaped such that they fit onto the contact surfaces of the respective coupling tube of a coupling and a conduit outer end which have to be fused together. The technique has the advantages that simple tools can be used and that the operations can be performed quickly (each operation lasts only a few seconds).

A coupling for multilayer conduits has been described in an earlier application WO 2012/030221 from the same inventor(s), the coupling comprising a coupling pipe with an inner wall which is reinforced with an adjacent reinforcing layer of a greater strength than the coupling pipe itself. Conduits are arranged over and on an outer surface of this coupling pipe, for which purpose a weld bush is utilized to make this outer surface of the coupling pipe plastic. If desired, a welding mandrel is utilized roughly simultaneously to make an inner surface of the conduit plastic. In a final state assembled with the conduit the coupling pipe is then located between the reinforcing layer on the inner side thereof and the conduit on the outer side thereof.

In this known configuration the reinforcing layer is provided with axial engaging elements, while the inner wall of the coupling pipe is provided with axial connecting elements which correspond with and connect to the engaging elements.

Such a reinforcing layer achieves that the coupling pipe is mechanically stronger and thereby better able to withstand the diverse torsional, bending and tensile forces to which the coupling is exposed during use.

In the known configuration the reinforcing layer can be a separately releasable component or form an element integrated with the coupling pipe. The coupling with reinforcing layer—if formed integrally—is preferably manufactured by injection moulding of two components.

The coupling with integrated reinforcing layer described in WO 2012/030221 has the features that the production thereof is based on injection moulding with two components and on the arranging of interacting axial elements on the inner wall of the coupling pipe and on or in the reinforcing layer.

For the reinforcing layer, which is cylindrical and therefore has in fact the form of a second pipe inside the coupling pipe, a requirement is at the same time set that it makes a very good contact with the inner wall of the coupling pipe in order to be able to properly absorb torsional and bending forces.

When the reinforcing layer is embodied as a loose separate sleeve, the dimensioning of the sleeve is highly critical since it must be close-fittingly enclosed inside the coupling pipe. This is also the case for the axial elements of the sleeve, which must connect closely onto the opposite axial elements of the inner wall of the coupling pipe.

In addition, the known configuration has further drawbacks. Axial outer ends of the coupling pipe of the coupling have for instance a conical form and the reinforcing layer extends to a distance from outer ends of the coupling pipe. Particularly with such a conical form, but also generally with a cylindrical form, of outer ends of the coupling pipe it is possible—when outer surfaces of precisely these outer ends of the coupling pipe are heated or when the conduit for connecting thereto is placed over the outer ends of the coupling pipe—that the reinforcing layer at a distance from the outer ends of the coupling pipe cannot prevent the exits or outer ends without this reinforcing layer of the coupling pipe from bending inward during the polyfusion welding as a result of the heat released here. Where it has been arranged in the interior of the coupling pipe, the reinforcing layer does however generally prevent the coupling pipe deforming inward when the conduit for connecting is heated or placed thereover. Gap formation can hereby occur between an exit or outer end of the coupling pipe and the conduit for connecting, whereby a problem-free flow through the conduits at the position of the couplings cannot be guaranteed, or pressure losses can even occur.

The object of the present invention is to at least reduce, if not obviate the above stated and/or other problems and/or drawbacks of known configurations with a reinforcing layer for a coupling pipe.

According to a first aspect, the invention provides for this purpose a reinforcing sleeve in an assembly with a coupling according to the appended main claim relating to the assembly.

Such a reinforcing sleeve first of all simplifies the insertion and placing thereof in a coupling pipe, while a close-fitting contact can be guaranteed after placing. A reinforcing sleeve at or in an outer end of the coupling pipe moreover brings about form-retention thereof, even when the outer ends of the coupling pipe are heated or the conduit is placed thereover. It makes no difference here whether the reinforcing sleeve is arranged during production of the coupling or provided as separate module.

Owing to the presence of the slit with an intermediate space which is variable it becomes possible to reduce the size of the contour of the reinforcing sleeve by pressing it lightly together, so that placing takes place without much resistance. Following placing the contour will increase in size again as a result of the resilient property of the sleeve, whereby it connects closely to the inner wall of the coupling pipe. In addition, the reinforcing sleeve is to some extent compressible in the situation where it is assembled with the coupling pipe, for instance during heating of outer surfaces of coupling pipes with a weld bush and also during placing of the conduit for connecting over the coupling pipe. The reinforcing sleeve thus imparts an aligning effect relative to the weld bush and also the conduit for connecting, even when the material of the coupling pipe is in a plastic state for fusing thereof with the conduit for connecting.

The dimensions and the form of the reinforcing sleeve are chosen here such that the outer periphery of the reinforcing sleeve in unloaded state is equal to or a fraction larger than the dimensions of the inner wall.

The operation of insertion and placing can thus be performed easily and quickly by the skilled person prior to the polyfusion welding of the coupling to a conduit outer end.

Because of the outward directed clamping force of the reinforcing sleeve on the inner wall of the coupling pipe there is substantially no risk of the assembly of reinforcing sleeve and coupling pipe unintentionally detaching before the polyfusion welding.

When the polyfusion welding is then carried out, a second advantageous effect occurs associated with the reinforcing sleeve according to the invention.

The slit extending at least in axial direction of the sleeve will, after placing inside the coupling pipe, have an intermediate space lying in the range between the space in unloaded state and the space in compressed state. This intermediate space is filled during the polyfusion welding with material of the inner wall of the coupling pipe, this material becoming to some extent plastic in the heat which is released during the polyfusion welding. The plastic material will shape itself to the outer surface of the reinforcing sleeve, and thus protrude at the position of the slit.

When the connected coupling pipe and the conduit outer end have cooled following polyfusion welding, a solidified protrusion of inner wall material remains behind inside the slit of the reinforcing sleeve. Just as the slit, this protrusion will extend in at least axial direction, whereby owing to the polyfusion welding step an element is formed on the inner wall which locks into the slit in the reinforcing sleeve.

It is thus possible without further provisions on reinforcing sleeve and coupling pipe to achieve an axial interaction between the two which increases the mechanical strength.

According to an embodiment of the invention, an outer end of the coupling pipe is provided with an edge. This edge functions as stop and supports correct and durable placing of the reinforcing sleeve inside the coupling pipe.

When the reinforcing sleeve has a conical contour, it is then recommended that the edge is present on the widening outer end of the reinforcing sleeve.

According to a further embodiment of the invention, a flange or the like on or of the reinforcing sleeve which in assembled state comes to lie against the edge is further provided with overhanging toothings. The overhanging toothings function as an additional fixation means or engagement when the edge of or flange on the reinforcing sleeve connects precisely to an outer end of a coupling pipe. It is hereby possible to arrange the reinforcing sleeve on, in or at a coupling such that the reinforcing sleeve remains thereon as a result of the engagement or fixation, and a polyfusion welding operation can be initiated without the danger of the sleeve detaching from the coupling.

In a further embodiment an assembly according to the present invention can have the features that at least one of the overhanging toothings comprises a hook-like member oriented into the coupling pipe in a situation assembled with the coupling. A mechanical coupling between the reinforcing sleeve and the coupling pipe can hereby be realized and it is possible to prevent a reinforcing sleeve being pulled out of a coupling pipe by a weld bush once this latter has heated the outer surface of a coupling pipe, as preparation for placing the conduit for connecting thereover, and is retracted. It can be favourable here for the coupling pipe of the coupling to comprise at least one recess for accommodating the hook-like member therein. Such a recess will be arranged in the outer surface of the coupling pipe in order to achieve the intended functionality.

In a preferred embodiment it can be advantageous for the coupling pipe to comprise in the interior thereof an edge against which the reinforcing sleeve, in the situation where it is assembled with the coupling, supports in the coupling pipe. The sleeve thus supports in the interior of the coupling pipe in order to define a reinforcement area where the sleeve has the intended functionality.

In a preferred embodiment it can be advantageous for the reinforcing sleeve and the coupling to be assembled during production of the coupling. Alternatively, the reinforcing sleeve and the coupling can be separate modules which can be assembled during (or immediately prior to) connection to a conduit.

The reinforcing sleeve according to the invention is preferably formed from a layer of material comprising a reinforced plastic such as PVDF, POM, PPSU or a similar material. Even a metal is possible.

This material must on the one hand be suitable for functioning as reinforcement, so that the mechanical strength of the coupling pipe as a whole is increased; this material must on the other have sufficient resilience and be sufficiently flexible to be suitable for the invention.

In a first preferred embodiment the reinforcing sleeve according to the invention has a contour which is conical. The reinforcing sleeve is thus suitable for placing inside a coupling pipe with an inner wall having a conical form.

In a second preferred embodiment the reinforcing sleeve according to the invention has a contour which is cylindrical. The reinforcing sleeve is thus suitable for placing inside a coupling pipe with an inner wall having a cylindrical form.

In a third preferred embodiment the reinforcing sleeve according to the invention has a contour comprising a conical and a cylindrical portion. The reinforcing sleeve is thus suitable for placing inside a coupling pipe with an inner wall having both a conical and a cylindrical form.

In the reinforcing sleeve according to the invention the outer surface is more preferably provided with a relief structure, preferably one or more recessed portions. This ultimately increases the surface area with which the inner wall of the coupling pipe can engage on the reinforcing sleeve.

As already elucidated above in respect of the slit in the reinforcing sleeve, the inner wall of the coupling pipe will deform plastically during the polyfusion welding such that the inner wall shapes itself to the adjacent outer surface of the reinforcing sleeve. When the outer surface is provided with a relief structure, a structure will have been formed—after cooling—on the inner wall which engages on the relief structure of the reinforcing sleeve. An additional engaging element is thus formed in addition to the protrusion of the inner wall inside the intermediate space of the slit in the reinforcing sleeve.

Together with the above stated advantages of the reinforcing sleeve, a coupling provided with the reinforcing sleeve according to the first aspect of the invention has the following advantages:
it is easy to assemble from a coupling and reinforcing sleeve and so highly suitable for use in practice;
after polyfusion welding to a conduit outer end the coupling provides sufficient points of engagement between coupling and reinforcing sleeve for the purpose of absorbing torsional and bending forces, whereby a robust coupling is obtained;
the coupling is highly suitable per se for durable coupling of multilayer conduits without the integrity of the conduits being lost. A very high quality welded connection is in particular obtained because the conduit outer end is completely enveloped due to being placed in the annular insertion space of the coupling.

In the assembly according to the invention the contour of the reinforcing sleeve is preferably conical or comprises a conical and a cylindrical portion, while the inner diameter of the coupling pipe increases at the outer end in outward direction.

Such a combination ensures an optimal close fit of the outer surface of the reinforcing sleeve on the inner wall of the coupling pipe.

In a preferred embodiment of the assembly according to the invention the coupling is formed substantially from material comprising PE, reinforced PE or PE-RT.

Such materials are the most usual for multilayer conduits, so that the coupling and the multilayer conduit thus have the same properties. This is advantageous not only for the application but also during coupling, since the welding device can be set to one specific temperature to plasticize the respective contact surfaces of the conduit and the coupling.

It is further recommended in the assembly according to the invention that the annular space of the coupling narrows in the direction of the wall such that the radial distance between the widened portion of the wall and the outer side of the coupling pipe decreases to a value smaller than the wall thickness of the conduit.

Such a design of the coupling makes it possible for the outer end of the pipe to be properly clamped in the annular space of the coupling and for an optimal fused connection to be obtained. Even more important is the additional effect that the fused connection or weld rib formed during the coupling by polyfusion welding is deformed in particular manner by the narrowing space. As a result of the narrowing space the weld rib formed between outer wall and widened portion is urged outward to some extent, whereby a protruding weld rib is obtained. The great advantage hereof is that on the basis of the protruding weld rib it is easy for a user to determine visually whether the obtained welded connection is of sufficient quality. It is thus possible in practice to carry out an immediate visual check on the obtained connection, this saving time.

In the assembly according to the invention the upright wall of the coupling more preferably has a widened portion of a length which is smaller in axial direction than the axial length of the coupling pipe as measured from the upright wall to the outer end of the coupling pipe, and preferably smaller by a factor of 4 or more.

The widened portion of the coupling pipe makes contact with the outer wall of the conduit, while the inner wall of the conduit makes contact with the outer side of the coupling pipe itself. Since the outer wall of a multilayer conduit is relatively vulnerable, it is recommended that the contact surface is relatively small here and the contact surface on the inner side of the conduit is relatively large. An optimal strength of the connection is thus obtained, while the outer wall of the conduit is exposed as little as possible to shear forces, whereby the protection of the metal layer by the outer wall remains intact.

According to a third aspect, the invention relates to a method for welding an outer end of a multilayer conduit to an assembly according to the second aspect of the invention,

wherein the method comprises the steps of:

inserting and placing the reinforcing sleeve in the corresponding inner space of the coupling pipe of the coupling in a manner such that the contour of the reinforcing sleeve connects substantially closely to an inner wall of the coupling pipe with the toothings in a position engaging the outer end of the coupling pipe,

heating the outer end of the conduit,

placing the outer end of the conduit in the insertion space of the coupling over the coupling pipe and over the toothings of the reinforcing sleeve in order to fuse the outer end with the coupling, and subsequently allowing cooling of the obtained fused connection,

wherein during performing of the method the inner wall of the coupling pipe deforms plastically due to the applied heat such that the inner wall shapes itself to the adjacent outer surface of the reinforcing sleeve, whereby after cooling there is created on the inner wall a structure which engages on the outer surface of the reinforcing sleeve.

In the context of the step or feature of heating the outer end of the conduit it is noted that the outer end of the relevant conduit can be heated directly here, but not also via the coupling. Diverse mandrels are available in the known art, wherein adapters can be applied for placing on a heating element. It is noted that, irrespective of the method of heating, it is important that a sufficient temperature is generated in the material of the coupling and/or the material of the conduit in order to bring about fusing of the conduit and the coupling.

Such a method makes it possible to obtain a durable weld between a conduit outer end and a coupling, wherein:
after polyfusion welding to a conduit outer end the coupling provides sufficient points of engagement between coupling and reinforcing sleeve for the purpose of absorbing torsional and bending forces so as to obtain a robust coupling;
a very high quality of welded connection is obtained in that the conduit outer end is fully enveloped by the coupling following placing in the annular insertion space;
a simple visual check on the quality of the weld is possible when the insertion space takes a narrowing form.

The invention is elucidated hereinbelow with reference to the accompanying drawings, in which:

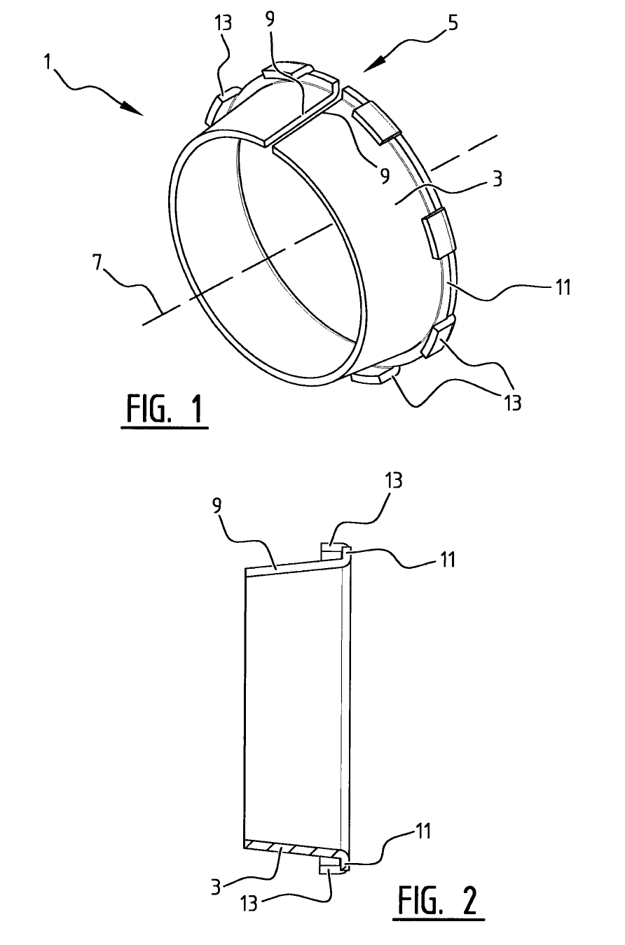

FIG. 1 is a perspective view of a reinforcing sleeve according to the invention;

FIG. 2 shows a cross-section of the coupling of FIG. 1;

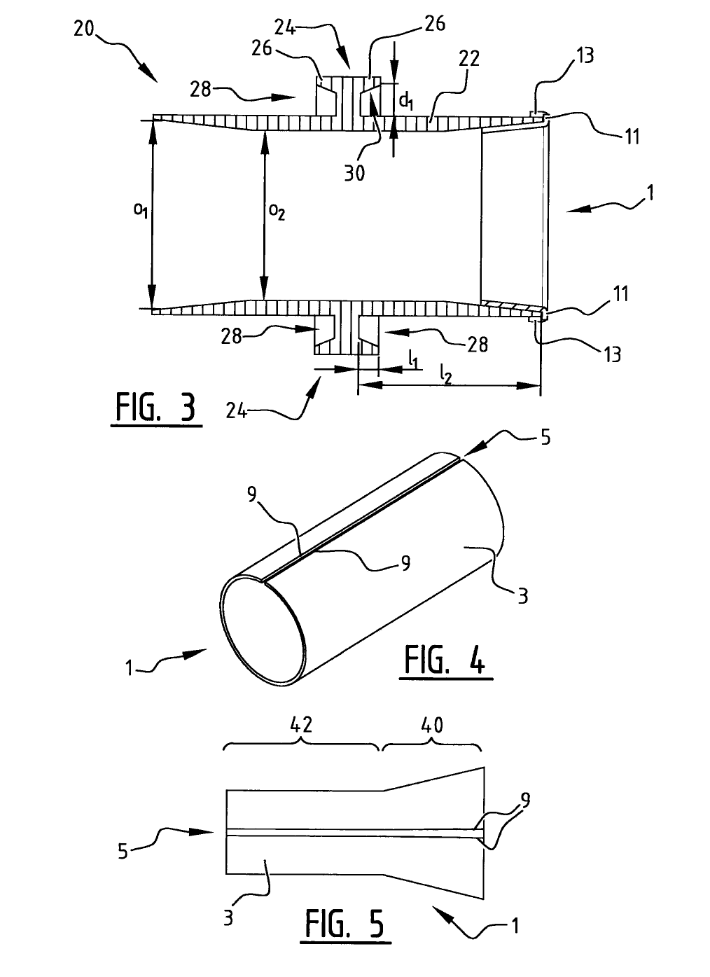

FIG. 3 shows a cross-section of an assembly according to the invention of a coupling with a reinforcing sleeve arranged therein;

FIG. 4 is a perspective view of an alternative embodiment of a reinforcing sleeve according to the invention;

FIG. 5 is a side view of a subsequent alternative embodiment of a reinforcing sleeve according to the invention;

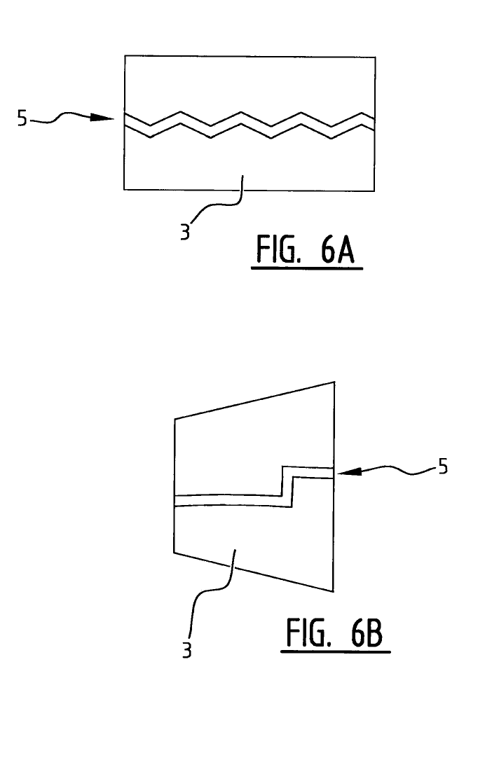

FIGS. 6A and 6B show side views of two different embodiments of a reinforcing sleeve according to the invention;

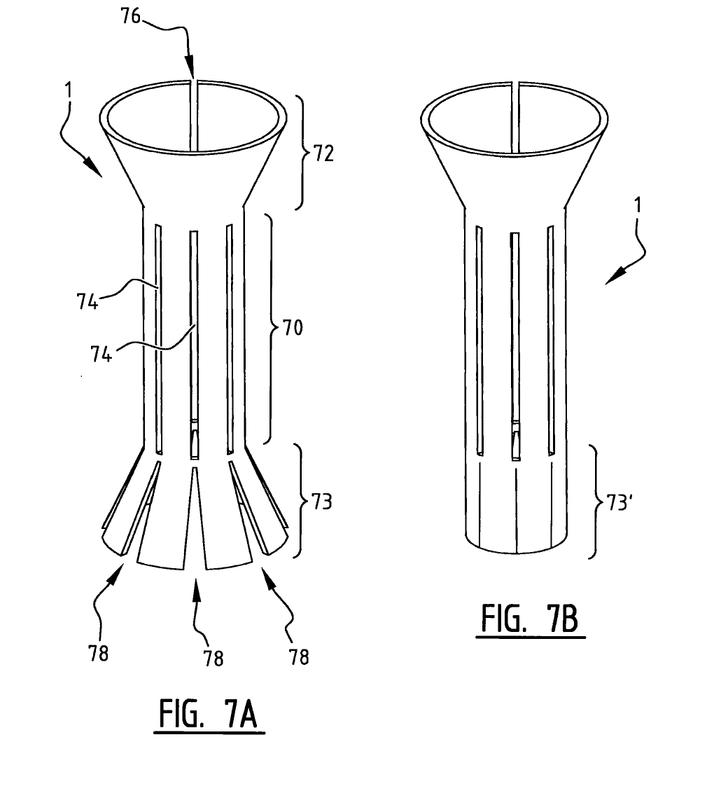

FIGS. 7A and 7B show perspective views of a subsequent alternative embodiment of a reinforcing sleeve according to the invention;

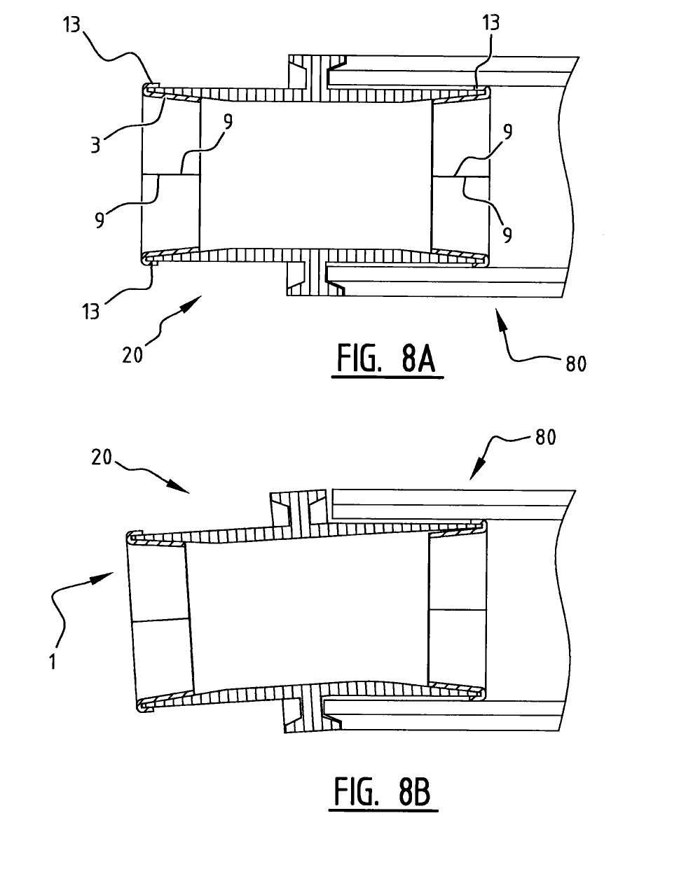

FIGS. 8A and 8B show a combination of a multilayer pipe or conduit, and coupling and a sleeve, in a properly aligned positioning and in a too hastily assembled state which displays misalignment; and

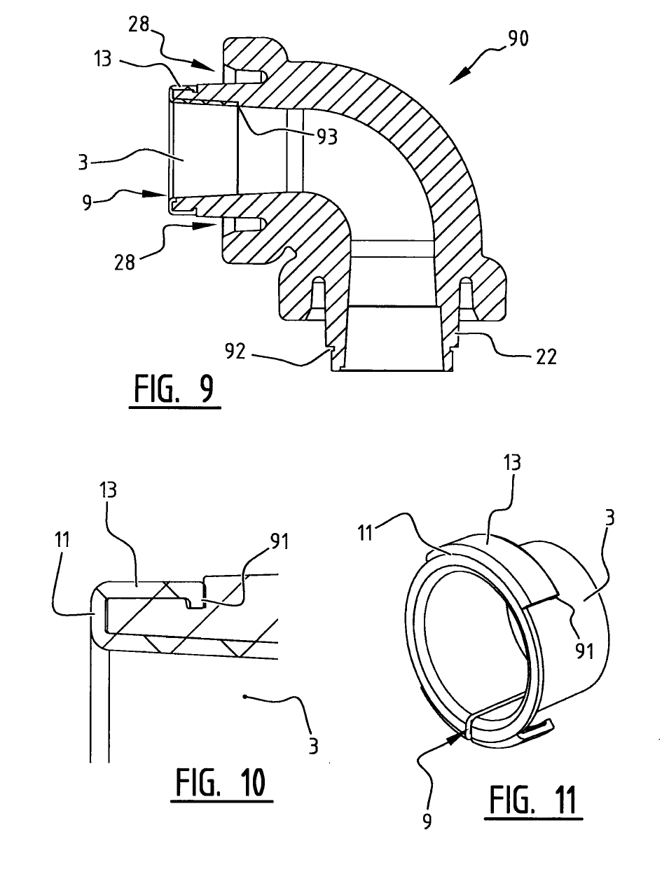

FIGS. 9, 10 and 11 show respectively a cross-sectional side view, a detail and a perspective view of an assembly and elements or components thereof according to the invention in a further additional embodiment.

FIG. 1 shows a reinforcing sleeve 1 formed from a curved layer 3 which is provided with a slit 5 extending parallel to the axial axis 7, wherein the intermediate space of slit 5 is enclosed by slit edges 9. The form of the sleeve is slightly conical, wherein an edge 11 is present over the whole periphery on the widening end, this edge moreover being provided with overhanging toothings 13.

The reinforcing sleeve according to the invention can be formed from a layer of material comprising a reinforced plastic, such as PVDF, POM, PPSU or a similar material. Even a metal is possible.

FIG. 2 shows a cross-section of the coupling of FIG. 1 in which the corresponding components are indicated with the same numbering. The cross-section is made in the plane of the axial axis 7 and the diameter of the sleeve at the position of slit 5.

FIG. 3 shows a cross-section in lengthwise direction of a coupling 20 provided according to the invention with a reinforcing sleeve 1.

The coupling is constructed from a coupling pipe 22 of substantially cylindrical form with an inner diameter o₂.

At the outer ends of coupling pipe 22 the inner diameter widens to a value o₁. The outer ends of the coupling pipe thus have a conical form. At the position of this conically running inner wall of the coupling pipe the reinforcing sleeve 1 is arranged with a correspondingly conical form. In this embodiment edge 11 covers the outer end of the coupling pipe and the overhanging toothings 13 clamp the sleeve fixedly to the outer end of the coupling pipe.

The coupling also comprises an upright wall 24 having a widened portion 26 on either side, whereby an annular insertion space 28 is created. This insertion space 28 narrows in the direction of the upright wall because of the form of the contact wall 30. At the position of the access to insertion space 28 the radial distance (d₁) between the widened portion of the wall and the outer side of the coupling pipe is equal to or greater than the wall thickness of a conduit outer end coupled by polyfusion welding to the coupling.

Widened portion 26 has a length l₁ which is about 10 times smaller than the length l₂ of the coupling pipe as measured from the upright wall to the outer end of the coupling pipe.

FIG. 4 shows an embodiment of a reinforcing sleeve 1 constructed from a tubular layer 3, the contour of which is cylindrical and provided with a slit 5 along the whole length which is enclosed by slit edges 9.

FIG. 5 shows an embodiment of a reinforcing sleeve 1 constructed from a tubular layer 3, the contour of which comprises a conical portion 40 and a cylindrical portion 42. The reinforcing sleeve is provided with a slit 5 along the whole length which is enclosed by slit edges 9.

FIG. 6A shows a variant of the embodiment according to FIG. 4, wherein slit 5 is embodied as a line with a zigzag form.

FIG. 6B shows a reinforcing sleeve with conical contour, wherein slit 5 takes a bent form.

FIG. 7A shows a reinforcing sleeve with a diabolo-like form, the two outer ends 72,73 of which are conically widening and the central portion 70 has a cylindrical contour. The central portion is provided with axial slots 74. The upper outer end 72 is provided with an axial slit 76. The lower outer end 73 is provided with eight slits 78 arranged at equal distances from each other.

Slits 78 can be squeezed together by a user to form a tube as shown in FIG. 7B. The squeezed-together entity designated 73′ can then be inserted into a coupling pipe of a type as shown in FIG. 3.

FIGS. 8A and 8B show two mounted states, wherein FIG. 8A is correctly aligned and FIG. 8B has been assembled too hastily and displays a misalignment of coupling 20 relative to a multilayer pipe or conduit 80. Sleeve 1 does not form any obstruction during deforming or bending of parts of coupling 20, and precisely such a deforming or bending is necessary, if not desirable, in order to realize a good seal between coupling 20 and pipe 80 when coupling 20 is placed in an angled orientation on, in or against the pipe during assembly thereof as shown in FIG. 8B. Once materials of coupling 20 and pipe 80 have fused, a correction of such a misalignment is no longer possible. Due to the heating of the material of coupling 20 and/or pipe 80 and/or the tapering form of the outer ends of the parts of coupling 20 which have to be inserted into pipe 80 during assembly, the outer ends of coupling 20 are in any event flexible so as to bring about the inclining position shown in FIG. 8B and to simultaneously also achieve a good seal between coupling 20 and pipe 80.

It is further noted in this context that in FIGS. 8A and 8B the slit edges 9 connect closely to each other. Melted material from coupling 20 can hardly penetrate the slit between slit edges 9, or can only do so to limited extent. When some measure of space remains between slit edges 9, cured material from coupling 20 can form a locking against radial rotation of sleeve 1. The penetration of melted material from coupling 20 into the slit between edges 9 will almost always occur to some extent. The reinforcing sleeve keeps the outer end of the coupling pipe round, and when the conduit for welding is pushed over the outer end of the coupling pipe over the toothings 13, the additional effect is achieved that, even due to this sliding movement, the reinforcing sleeve is fixed properly and additionally on the sole basis of a clamping action of the toothings.

When the coupling pipe with support sleeve is inserted into the welding device (weld bush or welding mandrel), the coupling pipe is compressed, i.e. pressed inward, since both the outer ends of the coupling pipe and the welding mandrel are conical. This compression can be accommodated because the reinforcing sleeve is provided with slit 9 and can thereby also bend inward; it thus temporarily acquires a smaller diameter during heating, but presses outward in order to enhance contact between material of outer ends of the coupling pipe and the weld bush.

When outer ends of the coupling pipe are pulled outward out of the weld bush the reinforcing sleeve can remain behind in the weld bush. Toothings 13 of the reinforcing sleeve provide a first solution to this. In a further improvement hook members 91 can be arranged on toothings 13. These can be pressed into plasticized material of outer ends of the coupling pipe, or the coupling pipe can comprise a groove 92 or other accommodation for receiving these hook members 91, wherein hook members 91 can hook into groove 92. Particularly when grooves 92 are wider in radial direction than the hook members, a clearance is provided for compression of the outer ends of the coupling pipe and of the reinforcing sleeve, wherein hook members 91 can slide in grooves 92.

This toothing 13 and hook members can be augmented with a horizontal/angled variant, whereby during welding (heating) and following connection the sleeve is and remains axially and radially anchored.

Different aspects can be distinguished here: if the sleeve is inserted DURING production of the fitting, sufficient grip for the reinforcing sleeve is provided as a result of an injection moulding process. The sleeve does not bend and lies firmly in the direction of the interior of the conduit it there is misalignment between the conduit and the coupling pipe and welding takes place in this position. The sleeve nevertheless retains the shape of outer ends of the coupling pipe during heating and welding and a reliable and properly sealed connection can nevertheless be effected.

If the sleeve is provided in modular form and the sleeve is inserted into the coupling pipe at a later time than during production of the coupling pipe, the sleeve temporarily lies “loosely” in an outer end of the coupling pipe of the coupling. Due to the slit 9 the sleeve can be compressed during heating with the weld bush and/or during the connection of the conduit for connecting and during bending toward the pipe wall when welded at an angle. As indicated above, a temporary anchoring is necessary in such a situation to prevent the sleeve remaining behind in the welding mandrel following heating of at least one outer end of the coupling pipe. From a technical viewpoint the sleeve thus has three anchors: 1. radial anchoring around the outer side of the fitting to absorb the axial force when the coupling pipe of the coupling is pulled out of a weld bush, so that the sleeve does not remain behind; 2. axial anchoring on top of the sleeve in order to obtain a connection between the coupling and the conduit after welding; and 3. the slit provides for the compression option and an anchoring against rotation during welding.

The sleeve lies against a shoulder or edge 93 in order to prevent the sleeve being pressed into the coupling pipe.

After examination of the foregoing disclosure of the present invention many alternative and additional embodiments will occur to the skilled person which all lie within the scope of protection therefor in accordance with the appended claims. It is noted here particularly, though not exclusively, that the slit in the reinforcing sleeve can remain wholly closed in the situation where it is inserted into the coupling and need not form an accommodation for receiving melted material of the coupling in order to form a locking with which radial rotation of the reinforcing sleeve can be prevented. It is additionally possible that dimensions of a slit between slit edges can be varied, for instance by providing break-out pieces, whereby material can be removed from the reinforcing sleeve and the dimensions of the sleeve made adjustable for a user, without overlap of slit edges in a situation where the sleeve is inserted in the coupling. All individually presented features, components and elements can be combined in embodiments not specifically shown or described. A zigzag shaped slit of FIG. 6A or 6B can thus be provided in a cylindrical sleeve such as that of FIG. 5.

1. Assembly of a reinforcing sleeve and a coupling,
the coupling comprising a coupling pipe, the coupling pipe being provided on the outer side with a radially upright wall, the radially upright wall being widened in axial direction at a radial distance from the outer side of the coupling pipe such that the outer side of the coupling pipe, the radially upright wall and a widened portion of the radially upright enclosing an annular insertion space into which an outer end of a conduit or of a welding device is directly insertable, and wherein the radial distance between the widened portion of the radially upright wall and an outer side of the coupling pipe at the position of the entry to the insertion space is such that it is equal to or greater than a wall thickness of the conduit or a thickness of the welding device; and
wherein the reinforcing sleeve is substantially tubular and designed for placing inside the coupling pipe,
the reinforcing sleeve comprising:
a slit extending at least in axial direction of the reinforcing sleeve, the slit being enclosed by slit edges of the reinforcing sleeve, the slit edges defining an intermediate space, the intermediate space being variable in that the sleeve takes a flexible and resilient form, and wherein dimensions and a form of the reinforcing sleeve are such that the contour of the reinforcing sleeve is arrangeable inside the coupling pipe and connects closely to an inner wall of the coupling pipe.

2. Assembly of claim 1, wherein the reinforcing sleeve further comprises an outer end with an edge, wherein in a situation where the reinforcing sleeve is assembled with the coupling the edge lies at or against an axial outer end of the coupling pipe and comprises toothings hanging over the axial outer end of the coupling pipe, which overhanging toothings, in a situation assembled with the coupling wherein the edge of the reinforcing sleeve connects to the outer end of the coupling pipe, form a locking or fixation for the purpose of arranging the reinforcing sleeve in the coupling pipe in order to prevent, as addition to the resilient flexibility, the reinforcing sleeve detaching from the coupling.

3. Assembly of claim 2, wherein at least one of the overhanging toothings comprises a hook-like member oriented into the coupling pipe in a situation assembled with the coupling.

4. Assembly of claim 3, wherein the coupling pipe of the coupling comprises at least one recess for accommodating the hook-like member therein.

5. Assembly of at claim 1, wherein the coupling pipe comprises in the interior thereof an edge against which the reinforcing sleeve, in the situation assembled with the coupling, supports in the coupling pipe.

6. Assembly of claim 1, wherein the reinforcing sleeve and the coupling are assembled during production of the coupling.

7. Assembly of claim 1, wherein the reinforcing sleeve and the coupling are separate modules which can be assembled during connection to a conduit.

8. Assembly of claim 1, wherein the contour of the reinforcing sleeve is conical or comprises a conical and a cylindrical portion, while the inner diameter of the coupling pipe increases at the outer end in outward direction.

9. Assembly of claim 1, wherein the reinforcing sleeve is formed from a layer of material comprising a reinforced plastic such as PVDF, POM, PPSU or a similar material, or a metal.

10. Assembly of claim 1, the contour of which comprises a conical and a cylindrical portion.

11. Assembly of claim 1, wherein at least the reinforcing sleeve has the form of a diabolo.

12. Assembly of claim 1, wherein an outer surface of the reinforcing sleeve is provided with a relief structure.

13. Reinforcing sleeve of or for an assembly as claimed in claim 1.

14. Reinforcing sleeve as claimed in claim 13, wherein the reinforcing sleeve includes an at least partially conical contour.

15. Reinforcing sleeve of claim 13, comprising a continuous slit extending in axial direction through the sleeve.

16. Method for welding an outer end of a conduit to an assembly, the method comprising:
inserting and placing a reinforcing sleeve in a corresponding inner space of a coupling pipe of a coupling in a manner such that a contour of the reinforcing sleeve connects substantially closely to an inner wall of the coupling pipe;
at least one of heating an outer end of the conduit and heating the coupling pipe of the coupling using a heating device, to be arranged at least one of in the conduit and over an outer end of the coupling pipe;
placing the outer end of the conduit in the insertion space of the coupling over the coupling pipe to fuse the outer end of the conduit to the coupling pipe of the coupling, and subsequently allowing cooling of the obtained fused connection,
wherein during at least one of the heating and the insertion the inner wall of the coupling pipe deforms plastically due to at least one of the applied heat and mechanical pressure; and
deforming the reinforcing sleeve, and holding an outer end of the coupling pipe, aligned with the reinforcing sleeve during the at least one of the heating and the insertion.

17. Assembly of claim 12, wherein an outer surface of the reinforcing sleeve is provided with one or more recessed portions.

18. The method of claim 16, wherein the deforming includes compressing.
